(19) United States
(12) Patent Application Publication
(10) Pub. No.: US 2004/0058048 A1
(43) Pub. Date: Mar. 25, 2004

(54) Dough composition and method for making tortillas with sodium phosphate compounds

(76) Inventors: Lisa Chedid, Kendall Park, NJ (US); John Joseph Toczek, Somerset, NJ (US); John David Brodie, Penndel, PA (US)

Correspondence Address: Charles N.J. Ruggiero, Esq., Ohlandt, Greeley, Ruggiero & Perle, L.L.P., 10th Floor, One Landmark Square, Stamford, CT, 06901-2682, US

(21) Appl. No.: 10/456,931

(22) Filed: Jun. 6, 2003

Related U.S. Application Data
(60) Provisional application No. 60/386,786, filed on Jun. 7, 2002.

(51) Int. Cl. A21D 2/00

(52) U.S. Cl. 426/551

(57) ABSTRACT

There is a dough composition. The composition has flour, shortening, water, a leavening system, and a dough conditioner of sodium phosphate compounds. There are also methods for making tortillas.

### CROSS REFERENCE TO A RELATED APPLICATION

The present application claims priority from U.S. Provisional Application Serial No. 60/386,786, filed Jun. 7, 2002. U.S. Provisional Application No. 60/386,786 is incorporated herein by reference.

### BACKGROUND OF THE INVENTION

1. Field of the Invention

The present invention relates to a dough composition having enhanced processing and physical properties. The present invention further relates to a dough composition for making tortillas with enhanced product properties. The present invention still further relates to a method for making tortillas with enhanced product properties.

2. Description of the Prior Art

Tortillas are manufactured commercially by forming a dough, flattening the dough to form dough flats, and baking the flats until they leaven and ultimately set. Representative manufacturing processes include pressing, die cutting and hand stretching. The dough typically comprises flour, a leavening system, and water. The leavening system comprises a leavening base and one or more leavening acids. The leavening base and leavening acid(s) react to yield carbon dioxide (neutralization reaction), which, along with any other gases present, leavens the dough.

A problem that can arise during manufacture of tortillas is inadequate pliability and strength of the dough. Conventionally, modifying the dough to make it more pliable has weakened the dough. Modifying the dough to strengthen it has made it less pliable. Inadequate pliability and strength negatively impact the handling and processing of the dough as well as the properties of the end product tortilla. Inadequate pliability renders the dough more difficult to handle and process. Inadequate strength reduces the ability of the dough to retain gas during handling and processing. Inadequate retention of gas decreases the degree or efficiency of leavening that can be obtained.

It would be desirable to have a dough composition having excellent pliability and strength. It would be desirable to have a method for manufacturing tortillas wherein the tortillas have excellent physical and product properties.

### SUMMARY OF THE INVENTION

According to the present invention, there is a dough composition. The composition has flour, shortening, water, a leavening system and a dough conditioner comprising a sodium phosphate compound substantially free of tetrasodium pyrophosphate (TSPP).

Further according to the present invention, there is a method for making tortillas. The method comprises providing the dough composition described above, dividing and rounding the dough composition to form a plurality of discrete dough balls, allowing the dough balls to relax, pressing the relaxed dough balls under heat and pressure to form relatively thinner dough flats, and baking (heating) the flats to form the tortillas.

Further according to the present invention, there is a method for making tortillas. The method has the following steps: a) providing the dough composition described above; b) allowing the dough composition to relax; c) flattening the relaxed dough composition to form relatively thinner dough flats; and d) baking the dough flats to form the tortillas.

Further according to the present invention, there is a method for making tortillas. The method has the following steps: a) providing the dough composition described above; b) allowing the dough composition to relax; c) dividing and rounding the relaxed dough composition to form a plurality of discrete dough balls, d) freezing the dough balls, e) thawing the dough balls to a higher temperature, f) flattening the dough balls to form relatively thinner dough flats and g) baking the dough flats to form tortillas.

Further according to the present invention, there is a method for making tortillas. The method has the following steps: a) providing the dough composition described above; b) allowing the dough composition to relax; c) rolling the dough to form a sheet; d) cutting the dough to form discrete dough flats and e) baking the dough flats to form the tortillas.

Further according to the present invention, there is a method for making tortillas. The method has the following steps: a) providing the dough composition described above; b) allowing the dough composition to relax; c) dividing and rounding the dough composition to form a plurality of discrete dough balls; d) allowing the dough balls to relax; e) rolling the relaxed dough balls to form relatively thinner dough flats; f) reshaping the periphery of the dough flats; and f) baking the reshaped dough flats to form the tortillas.

### DETAILED DESCRIPTION OF THE INVENTION

It was found surprising that a dough could be formulated to provide enhanced pliability and strength. It was found surprising that there could be a method for manufacturing tortillas having enhanced physical and product properties.

In the present invention, a dough having enhanced pliability and strength was formulated by incorporating a dough conditioner in the form of one or more sodium phosphate compounds except for tetrasodium pyrophosphate. Useful sodium phosphate compounds include but are not limited to monosodium phosphate (MSP), disodium phosphate (DSP), trisodium phosphate (TSP), sodium tripolyphosphate (STPP) and sodium hexametaphosphate (SHMP). Sodium phosphates have heretofore been used as an additive in some dairy and meat products, but have not been used as a dough conditioner.

The sodium phosphate compounds can be present in an amount effective to improve one or more of the following features in end product tortillas: cell structure, height, diameter, roundness, weight, volume, rollability, color (whiteness), shelf life, and opacity. The sodium phosphate compounds can also be present in an amount effective to improve dough pliability and/or strength. The sodium phosphate compounds will typically be present at from 0.1 wt % to about 2 wt %, more typically at from about 0.1 to about 1.0 wt %, and most typically at from 0.3 to about 0.6 wt % based upon the weight of the flour (baker's percent or flour weight basis).

The composition and method of the present invention can be used to make flour tortillas. Flour is derived from a grain such as wheat. The flour used must have sufficient gluten content and quality to withstand processing and retain gas. Flour sold commercially for home use and for food product manufacturing typically is typically of sufficient content and quality with which to manufacture tortillas. An example of a suitable flour is that having a protein content of about 9 to about 14 wt % and preferably about 9 wt % to about 12 wt % based upon flour weight.

The term “shortening” is used to describe any animal or vegetable based oils or fats added to the dough to facilitate lubrication and processability. Shortening is preferably derived from hydrogenated vegetable based oils or fats.

Salt may optionally be added to the flour to toughen and strengthen the dough. Salt can enhance product flavor and shelf stability and dough processability. Salt is typically employed at about 0.5 wt % to about 5 wt % and most typically about 1 wt % to about 3 wt %

The leavening system comprises a leavening base and a leavening acid. The leavening base is preferably sodium bicarbonate. The leavening acid may be any known in the art, such as sodium aluminum phosphate (SALP), monosodium phosphate (MSP), sodium acid pyrophosphate (SAPP), sodium aluminum sulfate (SAS), monocalcium phosphate (MCP), dicalcium phosphate dehydrate (DCPD), and organic acids such as citric acid and fumaric acid. For purposes of this invention, TSPP is not considered a leavening acid. Additional teachings to leavening systems are described in Chemical Leavening Agents, Encyclopedia of Chemical Technology, 4^{th} Ed., vol. 3, pp. 893-901 (1992), which is incorporated herein by reference.

Dough is formed by mixing the flour with shortening, water, and a leavening system. The shortening is typically about 2 to about 20 wt % and more typically about 6 to about 10 wt % based upon the flour weight. Water is typically about 40 to about 100 wt % and more typically about 50 to about 60 wt % based upon the flour weight and can be optimized by water absorption measurements using a farinograph to a 750 BU (Brabender Units) level. The complete leavening system (base plus acid) is typically about 0.5 to about 8.0 wt %, more typically about 0.5 to about 3 wt % and most typically about 1 to about 2 wt % based upon the flour weight.

The tortillas are generally prepared by forming a dough, flattening the dough to form dough flats and baking the flats until they leaven and set. A number of manufacturing methods are employed commercially. The methods include pressing, die cutting and hand stretching.

The pressing method has the following steps: a) preparing the dough composition as described above, b) allowing the dough to relax, c) dividing and rounding the dough composition to form a plurality of discrete dough balls, d) allowing the dough balls to relax, e) pressing the relaxed dough balls under heat and pressure to form relatively thinner dough flats, and f) baking the dough flats to form the tortillas.

After the dough is formed, the dough is proofed, i.e. allowed to rest for a period of time sufficient to enable protein molecular chains to relax and ingredients to substantially hydrate. Preferably, the dough is allowed to proof for about 5 minutes or more. Relaxation is important to achieving good end product physical properties. Optionally, a dough temperature of about 85° F. to about 100° F. (about 32.2° C. to about 37.8° C.) may be maintained during proofing. The dough is then divided and rounded to form a plurality of discrete dough balls. The balls may be any shape but preferably are substantially spherical.

The dough balls are allowed to rest for a period of time sufficient to enable protein molecular chains to relax. Relaxation is important to achieving good end product physical properties. The time of relaxation is preferably at least about 5 minutes, more preferably at least about 10 minutes and most preferably about 10 to about 30 minutes. The addition of sodium phosphates to the dough may reduce the time required for relaxation. Optionally, the dough may be maintaining a dough temperature of about 85° F. to about 100° F. (about 32.2° C. to about 37.8° C.) during relaxation.

The relaxed dough balls are then pressed under elevated heat and pressure between platens or other flat surfaces to form relatively thinner flats. Preferably, one platen is stationary and the other actuates. The temperature and pressure will vary depending on the size and shape of the balls, properties of the dough, and the desired thickness and/or diameter of the flats. Pressure applied to the balls preferably ranges from about 400 to about 1200 pounds per square inch (about 2758 to about 7585 kilopascals). Temperature of the platens preferably varies from about 350° F. to about 450° F. (about 177° C. to about 232° C.) and most preferably from about 350° F. to about 450° F. (about 177° C. to about 232° C.). The temperature of the dough balls just prior to pressing preferably ranges from about 85° F. to about 100° F. (about 32.2° C. to about 37.8° C.).

The dough flats are then baked (heated) at an elevated temperature or temperature profile to a setting point to form tortillas. During baking, the dough flats leaven upon generation of carbon dioxide and expansion of gases. Baking temperatures preferably range from about 360° F. to about 500° F. (about 182° C. to about 260° C.). Baking times preferably range from about 10 seconds or more, more preferably 30 to about 50 seconds and most preferably about 35 to 45 seconds. Baking may take place at a constant temperature or at different temperatures. Ovens may have a single temperature zone or tier or multiple temperature zones or tiers. Useful oven types include but are not limited to single-tier and three-tier ovens. In a preferred method, baking takes place in a three-tiered or multi tiered oven.

After baking, the tortillas are cooled and packaged for shipment to consumers. The tortillas are preferably cooled to a temperature of about 30° C. or less. Cooling prevents tortillas from sticking together and limits moisture condensation inside packaging.

The die cutting method has the following steps: a) preparing the dough composition as described above, b) allowing the dough to relax as described above, c) rolling the dough to form a sheet, d) cutting the dough to form discrete dough flats, e) baking (heating) the dough flats to form tortillas as described above. The dough is typically rolled to sheet form by passing it between juxtapositioned rollers although any method for flattening dough known in the are such as pressing or use of a rolling pin over a stationary surface may be employed. The sheet may cut by any means known in the art such as with a die, cutout or raised surface.

The hand stretch method is similar to the pressing method except that relaxed dough balls are rolled to form relatively thinner dough flats rather than by pressing. Rolling of dough balls is carried as described above for the rolling of dough into a sheet. The periphery of the dough flats may optionally be modified by manipulation by hand or other mechanical contact. The dough flats are then baked (heated) to form tortillas as described above.

Other commercial methods employ freezing steps. Relaxed dough balls are formed as described above and are frozen for storage and/or transport to restaurants and food service facilities. The frozen dough balls are allowed to thaw to machineable higher temperatures and then are pressed or rolled to form discrete dough flats, which are then baked (heated) to form tortillas as described above.

Other teachings to methods for making tortillas also described in the publication Methods to Prepare and Evaluate Wheat Tortillas, Cereal Foods Worlds, vol. 36, no. 3, pp. 315 to 322 (1991), which is incorporated herein by reference.

The methods of the present invention can afford tortillas that have enhanced physical and product quality, such as better texture, cell structure, color (whiteness), appearance, opacity, eating quality, pliability, rollability and the like.

The dough composition may optionally comprise other ingredients, such as preservatives, emulsifiers, reducing agents, acidulants and antimicrobials. Such ingredients can improve dough machineability, tortilla appearance and shelf life.

If desired, corn-based additives or ingredients, such as corn meal or corn flour, can be added to wheat-based flour to make tortillas.

The present invention is useful in dough compositions for other than tortillas. The present invention is useful in dough compositions for focaccia, pita, naan and roti breads.

Unless otherwise indicated, percentages and parts are expressed in the following examples on a flour weight basis.

### EXAMPLES

Tortillas were prepared with sodium phosphates in accordance with the present invention. Tortillas were also prepared without sodium phosphates (controls). Tortillas and doughs were tested for physical properties.

Leavening acids employed include SAPP (BP PYRO by Rhodia) and monocalcium phosphate (MCP) (Regent by Rhodia).

Preparation of Wheat Tortilla Dough

The flour used was ConAgra Buccaneer Bakers Flour (malted and bleached). The moisture absorption for the flour as determined by farinograph was 53%. Tap water was used for all experiments.

A Hobart mixer was used for dough mixing. The mixing procedure was as follows: a) dry materials were mixed for 2 minutes at low speed using a paddle; b) shortening was then added and mixed continuously another 6 minutes; c) the mixer blade was changed to a hook type, and water was added and the dough mixed about 2 minutes at low speed until no dry flour could be seen; d) the dough was then mixed at medium speed about 2-4 minutes until a soft, cohesive, and pliable dough was obtained. After mixing, the dough was covered with plastic film and rested (relaxed) for 5 minutes at room temperature (21° C.).

The rested dough was manually pre-sheeted, mechanically pressed, divided into 36 dough pieces, and rounded into small dough balls for 35 seconds using a Dutchess dough divider and rounder. The dough balls were covered with plastic film and rested 10 minutes at room temperature (21° C.) before they were hot pressed and baked.

A pilot line including pressing platens, a three-tier gas oven (model OP01004-07 Micro Combo W/Head), and a five tier cooling conveyor (model OCC1208-03 by Lawrence Equipment) was used to prepare the tortillas. Both top and bottom hot plate temperatures were set at 196° C. Press time was 0.8 seconds using a medium pressure setting. The oven temperature was set at 204° C., and the oven dwell time was 40 seconds.

Total tortilla cooling time at room temperature after baking and just before packaging was 20 minutes, i.e., 2 minutes on the cooling conveyer and 18 minutes on a table with each tortilla individually separated. Tortillas were then stored in polyethylene bags at room temperature (21° C.) for 33 (or more) days. There were a maximum of 15 tortillas per bag.

Wheat Tortilla Dough Evaluation

The pliability of tortilla dough was subjectively evaluated during its manual pre-sheeting (after a 5-minute rest) on a 1-5 scale where 1=very stiff with poor extensibility; 2=stiff and poorly extensible; 3=fairly soft and extensible; 4=soft with good extensibility and elasticity; 5=soft and having an excellent balance between extensibility and elasticity. Dough softness was rated on a 1-5 scale as well with higher numbers (points) indicating softer dough characteristics.

Dough ball smoothness, after the 10-minute resting period, was rated using a 1-5 point scale. Higher numbers (points) indicate smoother dough balls (desirable).

Wheat Tortilla Characterization

Ten (10) 1-day stored tortillas were stacked and measured to determine the average tortilla thickness (mm) and weight (g) per piece. Baked tortilla diameters (cm) were measured at two diagonals on each of 10 tortillas per sample, and the overall mean was calculated. Specific volume (cm³/g) was calculated based on dimension and weight.

### Control and Examples 1 to 3

Tortillas were prepared using 0.6 wt % sodium phosphates. Dough composition is set forth in Tables 1 and 2. Tortillas were prepared using the methods described above.

Dough conditioners tested were DSP, TSP and SHMP. The Control did not use a dough conditioner. The leavening acids used were MCP and SAPP.

TABLE 1
Dough Composition

Compositions

| Ingredient | Control | DSP | TSP | SHMP |
|---|---|---|---|---|
| Flour | 1000 | 1000 | 1000 | 1000 |
| Salt | 15 | 15 | 15 | 15 |
| SSL | 5 | 5 | 5 | 5 |
| Potassium Sorbate | 4 | 4 | 4 | 4 |
| Sodium Propionate | 5 | 5 | 5 | 5 |
| Sodium Bicarbonate | 5 | 5 | 5 | 5 |
| MCP | 1.36 | 1.36 | 1.36 | 1.36 |
| SAPP | 5.43 | 5.43 | 5.43 | 5.43 |
| Dough conditioner | | 6 | 6 | 6 |
| Coated Fumaric | 3.5 | 3.5 | 3.5 | 3.5 |
| Shortening | 60 | 60 | 60 | 60 |
| Water | 525 | 525 | 525 | 525 |

TABLE 2
Dough Evaluation

Evaluation

| Characteristic | Control | DSP | TSP | SHMP |
|---|---|---|---|---|
| Dough Smoothness (1-5) | 3.8 | 4.2 | 4.2 | 3.5 |
| Dough Softness (1-5) | 4.0 | 4.0 | 3.8 | 4.2 |
| Dough Pliability (1-5) | 4.0 | 4.2 | 3.5 | 4.2 |
| Specific Volume (cm³/g) | 1.82 | 2.07 | 2.16 | 1.92 |

DSP and TSP improved smoothness of the dough. DSP also improved pliability. SHMP improved softness and pliability.

It should be understood that the foregoing description is only illustrative of the present invention. Various alternatives and modifications can be devised by those skilled in the art without departing from the invention. Accordingly, the present invention is intended to embrace all such alternatives, modifications and variances that fall within the scope of the appended claims.

What is claimed is:

1. A dough composition, comprising:
a) flour;
b) shortening;
c) water;
d) a leavening system; and
e) a sodium phosphate compound substantially free of tetrasodium pyrophosphate.

2. The composition of claim 1, wherein the sodium phosphate compound is present from about 0.1 wt % to about 2 wt % based upon the flour weight.

3. The composition of claim 1, wherein the sodium phosphate compound is present from about 0.3 wt % to about 0.6 wt % based upon the flour weight.

4. The composition of claim 1, wherein the sodium phosphate compound is selected from the group consisting of monosodium phosphate, disodium phosphate, trisodium phosphate, sodium tripolyphosphate and sodium hexametaphosphate.

5. The composition of claim 1, wherein the sodium phosphate compound is present in an amount effective to enhance a property of an end product tortilla selected from the group consisting of cell structure, rollability, whiteness, pliability, shelf life, and opacity.

6. The composition of claim 1, wherein the leavening System is about 0.5 wt % to about 8.0 wt % based upon flour weight.

7. The composition of claim 1, wherein the leavening system is about 0.5 wt % to about 3 wt % based upon the flour weight.

8. The composition of claim 1, wherein the leavening system is about 1 wt % to about 2 wt % based upon the flour weight.

9. The composition of claim 1, wherein the shortening is about 2 wt % to about 20 wt % based upon the flour weight.

10. The composition of claim 1, wherein the water content is about 40 wt % to about 100 wt % based upon the flour weight.

11. The composition of claim 1, wherein the water content is about 50 wt % to about 60 wt % based upon the flour weight.

12. The composition of claim 1, wherein the sodium phosphate compound is present from about 0.1 wt % to about 1 wt % based upon the flour weight, and wherein the sodium phosphate compound is selected from the group consisting of monosodium phosphate, disodium phosphate, trisodium phosphate, sodium tripolyphosphate and sodium hexametaphosphate, and wherein the leavening system is about 0.5 wt % to about 3 wt % based upon the flour weight, and wherein the shortening is about 2 wt % to about 20 wt % based upon the flour weight, and wherein the water content is about 40 wt % to about 100 wt % based upon the flour weight.

13. The composition of claim 1, wherein the dough composition is a tortilla dough composition.

14. The composition of claim 10, wherein the dough composition is a tortilla dough composition.

15. The composition of claim 1, wherein the dough composition is a tortilla dough composition.

16. The composition of claim 1, wherein the dough composition is selected from the group consisting of a focaccia dough composition, a pita dough composition, a naan dough composition and a roti dough composition.

17. The composition of claim 1, wherein the composition is frozen.

18. A method for making tortillas, comprising:
a) providing a dough composition according to claim 1;
b) dividing and rounding the dough composition to form a plurality of discrete dough balls;
c) allowing the dough balls to relax;
d) pressing the relaxed dough balls under elevated heat and pressure to form relatively thinner dough flats; and
e) baking the flats to form the tortillas.

19. The method of claim 18, wherein the dough balls are allowed to relax for at least about 5 minutes.

20. The method of claim 18, wherein the dough balls are allowed to relax for at least about 10 minutes.

21. The method of claim 18, wherein the dough balls are allowed to relax for about 10 to about 30 minutes.

22. The method of claim 18, wherein the relaxed dough balls are pressed between platens at about 400 to about 1100 pounds per square inch.

23. The method of claim 18, wherein the relaxed dough balls are pressed between platens, and wherein the platens are maintained at a temperature of about 350° F. to about 500° F.

24. The method of claim 18, wherein the relaxed dough balls are at a temperature of about 85° F. to about 100° F. during pressing.

25. The method of claim 18, wherein the dough flats are baked for about 10 seconds or more.

26. The method of claim 18, wherein the dough flats are baked to a temperature of about 360° F. to about 500° F. for about 30 to about 50 seconds.

27. The method of claim 26, wherein the dough flats are baked for about 35 to about 45 seconds.

28. The method of claim 18, wherein the sodium phosphate compound is present from about 0.1 wt % to about 2 wt % based upon the flour weight.

29. The method of claim 18, wherein the sodium phosphate compound is present from about 0.3 wt % to about 0.6 wt % based upon the flour weight.

30. The method of claim 18, wherein the sodium phosphate compound is selected from the group consisting of monosodium phosphate, disodium phosphate, trisodium phosphate, sodium tripolyphosphate and sodium hexametaphosphate.

31. The method of claim 18, wherein the tetrasodium pyrophosphate is present in an amount effective to enhance a property of an end-product tortilla selected from the group consisting of cell structure, rollability, whiteness, pliability, shelf life, and opacity.

32. The method of claim 18, wherein the sodium phosphate compound is present from about 0.1 wt % to about 2 wt % based upon the flour weight, and wherein the sodium phosphate compound is selected from the group consisting of monosodium phosphate, disodium phosphate, trisodium phosphate, sodium tripolyphosphate and sodium hexametaphosphate, and wherein the leavening system is about 0.5 wt % to about 8 wt % based upon the flour weight, wherein the shortening is about 2 wt % to about 20 wt % based upon the flour weight, and wherein the water content is about 40 wt % to about 100 wt % based upon the flour weight.

33. A method for making tortillas, comprising:
a) providing a dough composition according to claim 1;
b) allowing the dough composition to relax;
c) flattening the relaxed dough composition to form relatively thinner dough flats; and
d) baking the dough flats to form the tortillas.

34. The method of claim 33, wherein the relaxed dough composition is divided and rounded to form a plurality of discrete dough balls, wherein the dough balls are frozen, wherein the dough balls are allowed to thaw to a higher temperature, and wherein the dough balls are flattened to form the dough flats.

35. A method for making tortillas, comprising:
a) providing a dough composition according to claim 1;
b) allowing the dough composition to relax;
c) rolling the dough to form a sheet;
d) cutting the dough to form discrete dough flats, and
e) baking the dough flats to form the tortillas.

36. A method for making tortillas, comprising:
a) providing a dough composition according to claim 1;
b) allowing the dough composition to relax;
c) dividing and rounding the dough composition to form a plurality of discrete dough balls;
d) allowing the dough balls to relax;
e) rolling the relaxed dough balls to form relatively thinner dough flats;
f) reshaping the periphery of the dough flats; and
g) baking the reshaped dough flats to form the tortillas.
